(19) United States
(12) Patent Application Publication
(10) Pub. No.: US 2018/0163430 A1
(43) Pub. Date: Jun. 14, 2018

(54) SUPPORT APPARATUS FOR A SWINGING GATE

(71) Applicant: Lyle Davis, KALISPELL, MT (US)

(72) Inventor: Lyle Davis, KALISPELL, MT (US)

(21) Appl. No.: 15/378,422

(22) Filed: Dec. 14, 2016

(51) Int. Cl. E04H 17/20; E05B 1/00; E05D 15/00; E04H 12/22; E05C 19/02

(52) U.S. Cl. CPC E04H 17/20; E05B 1/003; E05D 2015/485; E04H 12/2238; E05C 19/02; E05D 15/00

(57) ABSTRACT

A gate support system for the free-end of a swinging gate. The system includes a first elongated support member; a second elongated support member, a foot member carried by the second elongated support member and being vertically moveable relative to the second elongated support member between raised and lowered positions; bias means for biasing the foot member to the raised position; and a locking mechanism for locking the foot member in a desired vertical position relative to the second elongated support member. When the gate has been pivoted to a desired position, the foot member can be pushed downwardly until it rests firmly on the ground. The locking mechanism will maintain the foot member in a lowered position where it will support the weight of the free-end of the gate. A handle can be activated to release the locking mechanism and enable the foot member to move to a raised position.

### FIELD

This disclosure relates to a support system for the free-end of a swinging gate or the like. More specifically, the support system may be manufactured with a gate or conveniently retrofitted on to an existing gate.

### BACKGROUND

A horizontally swinging gate is pivotally mounted at one end by way of hinges that are anchored to a support post or column, etc. In the widely used configuration, the gate is able to swing or pivot relative to the support post or column when the gate is unlatched so as to enable passage of people, animals, or machinery through a fenced or walled barrier.

A known drawback of this type of gate is that most of the weight must be supported by the hinges, especially when the gate is in an open position. This puts a considerable strain on the hinges, particularly when the gate is quite long or is constructed of a heavy material.

One solution alleviates the strain on the hinged end of a heavy gate by way of a wheel, which is installed at the base of the free-end of the gate to support the free-end. This solution is effective when the ground surface is asphalt or concrete paved, or minimally comprises a hard-packed and well graded soil surface. So, effective use of this support mechanism is not possible or convenient in many circumstances. Further, a wheeled support will not adequately maintain a gate in a fixed position when the wheel support is positioned on a slope or high wind (e.g. when on a hill or if the wind is blowing against the gate).

Therefore, a need exists for a gate support system having the features and advantages of prior art gate support systems but having a unique configuration that allows fast and convenient gate positioning and re-positioning. There is a need for a foot-type support mechanism that allows a similar level of simplicity in opening, closing, and repositioning the free-end of a gate

### SUMMARY

In the view of the foregoing disadvantages inherent in the known gate latches and support mechanisms, an improved method for supporting the free-end of a swinging gate is herein disclosed.

In accordance with this disclosure, there is provided a system for supporting a free-end of a swinging gate comprising: an first tubular elongated support having a first circumference; a removable end cap positioned on a first end of the first elongated support; a second tubular elongated support having a second circumference, the second circumference being less than the first circumference, such that the second elongated support is slid into a second end of the first tubular elongated support; a retracting spring having a spring first end attached to the end-cap and a spring second end attached to the first end of the of the second tubular support; a pivoting handle and assembly affixed to and outer surface of the first tubular support member, wherein an engaging end of the pivoting handle passes through an opening in the first tubular support member to engage the second elongated support; and a foot member affixed to a second end of the second tubular support, wherein the foot member comprises a generally planner material for engaging a surface area.

In various embodiments, the gate support system may be suitably secured to the free-end of an existing gate structure, or included as a component of a gate at the time of manufacture.

Those of ordinary skill in the art will appreciate that as used herein “gate” may encompass any type and use of a device intended to allow passage of people, animals, and machines across a fenced or walled area. The specific examples presented herein are provided for the purpose of explanation only and not to limit the scope in any way. For example, an elongated steel gate is referenced herein with regard to the disclosed gate support system. However, those of ordinary skill in the art will appreciate that similar benefits may be realized through implementation in plastic gates, wooden gates, walkway-width gates, and the like

Other advantages and features of the gate support system of the invention will be apparent from the following detailed description and the accompanying drawings.

### BRIEF DESCRIPTION

The subject matter of the present disclosure is particularly pointed out and distinctly claimed in the concluding portion of the specification. A more complete understanding of the present disclosure, however, may be obtained by referring to the detailed description and claims when considered in connection with the drawing figures, wherein like numerals denote like elements.

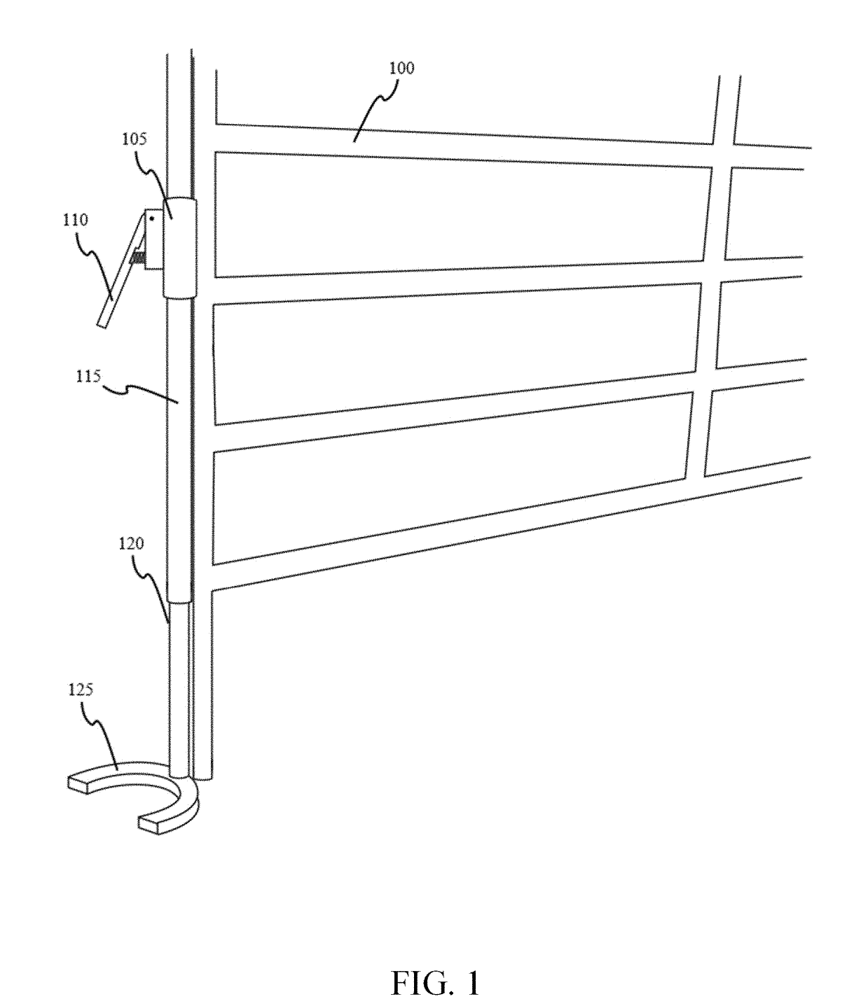

FIG. 1 illustrates a tubular steel gate having an exemplary engaged gate support system, in accordance with various embodiments;

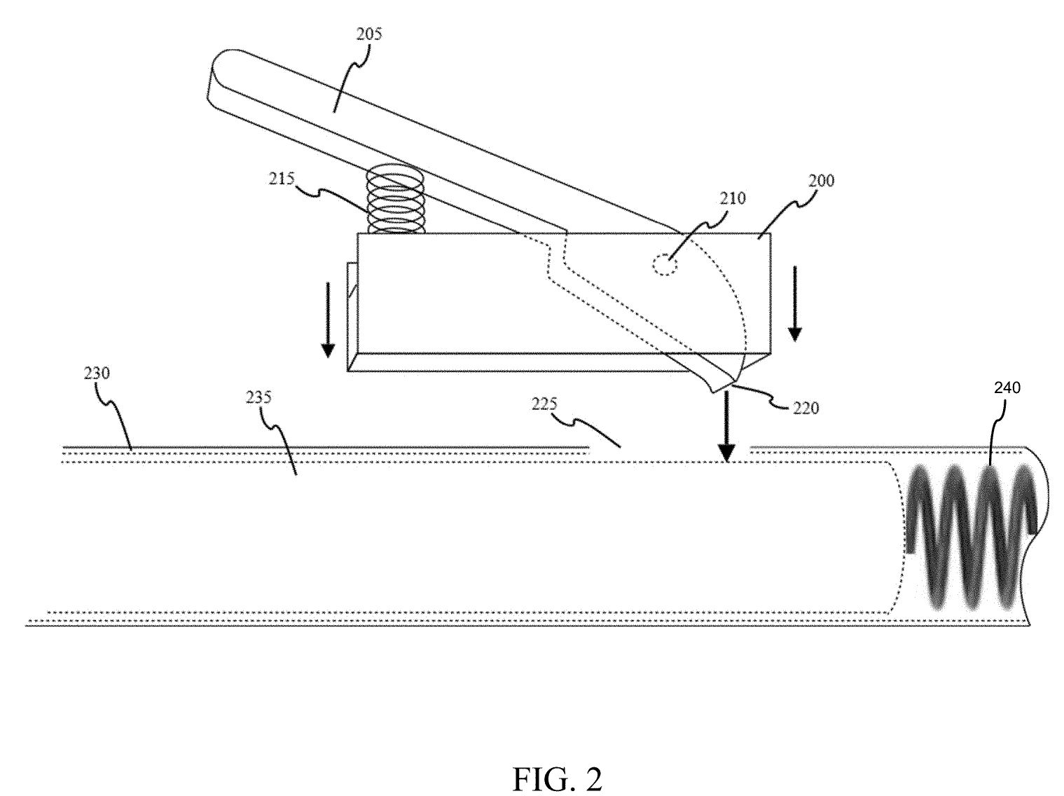

FIG. 2 illustrates a cutaway/transparent view of various components for an exemplary gate support system, in accordance with various embodiments;

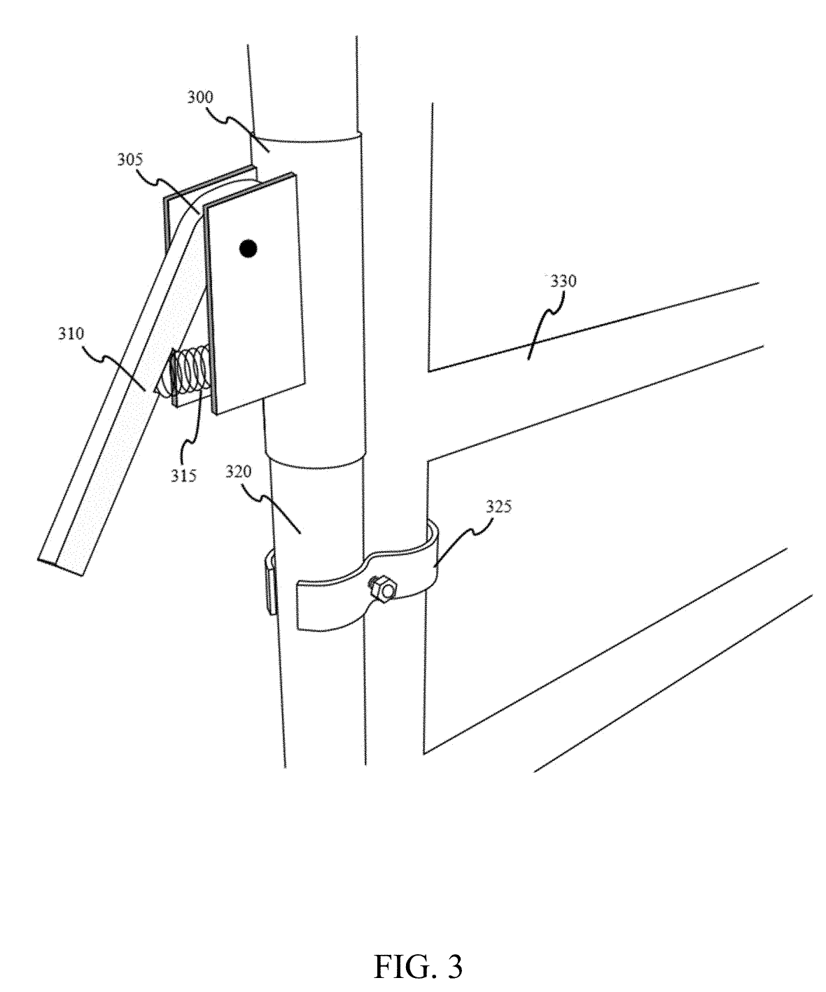

FIG. 3 is a perspective detail view of a locking mechanism for an exemplary gate support system, in accordance with various embodiments; and

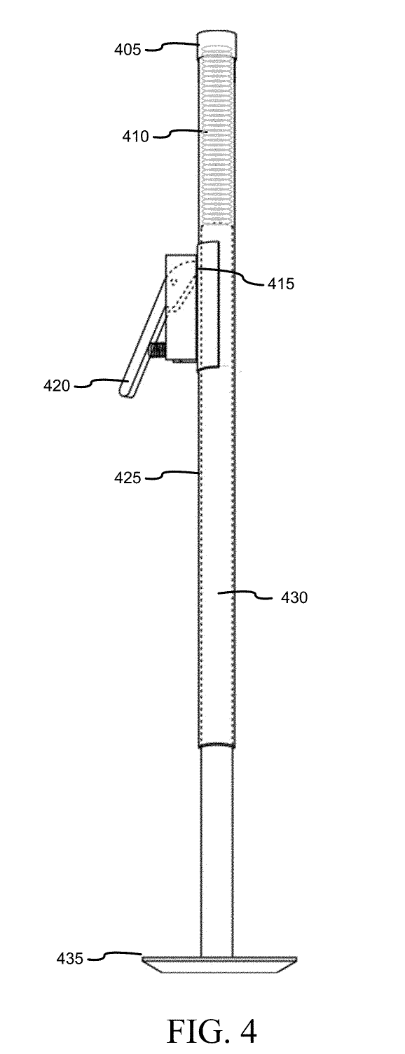

FIG. 4 is a macro view of the components for an exemplary gate support system, in accordance with various embodiments.

### DETAILED DESCRIPTION

The detailed description of various embodiments herein makes reference to the accompanying drawings and pictures, which show various embodiments by way of illustration. While these various embodiments are described in sufficient detail to enable those skilled in the art to practice the disclosure, it should be understood that other embodiments may be realized and that logical and mechanical changes may be made without departing from the spirit and scope of the disclosure. Thus, the detailed description herein is presented for purposes of illustration only and not of limitation. For example, the steps recited in any of the method or process descriptions may be executed in any order and are not limited to the order presented. Moreover, any of the functions or steps may be outsourced to or performed by one or more third parties. Furthermore, any reference to singular includes plural embodiments, and any reference to more than one component may include a singular embodiment.

In general, the gate support mechanism allows a user to conveniently secure a pivoting gate in any position, such that the free-end of the gate does not bear the downward pressure from the overall weight of the gate structure. The disclosed gate support mechanism includes a first extended tubular member, a second extended tubular member, a retracting spring, a locking mechanism, and a foot member. The interconnections and functions of these and other components will be described herein.

The disclosure describes a unique apparatus for supporting a free-end of a swinging gate while at rest. In various embodiments, the disclosed gate support system is implemented within a typical gate configuration, wherein a first end is hinged to a support post or column and the opposing end is a free-end. The free-end of the gate is able to move horizontally between open and closed positions. In various embodiments, a free-end includes a locking mechanism for securing the gate in a closed position.

In other embodiments, a locking mechanism that engages the free-end and is positioned on a stationary post, wall, or similar. Specifically, the disclosed gate support system is incorporated into the free-end of the gate, either at the time of manufacture of the gate or as an add-on for existing gates.

Systems and methods are described relative to the corresponding figures. In the detailed description herein, references to “various embodiments”, “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

FIG. 1 illustrates a tubular steel gate having an exemplary engaged gate support system, in accordance with various embodiments. When the gate support system is engaged, a foot member 125 is configured to engage the surface (e.g., ground) while the gate 100 is in a parked position. The foot member 125 is the lowermost component of the gate support system and is affixed to an end of a second elongated support member 120. In one embodiment, the user simply pushes down on the foot member 125 until it contacts the ground. For example, this may be done by stepping on the foot member 125 to press the foot member 125 down until downward motion is stopped by the ground. The locking mechanism 105 includes a spring, which exudes constant pressure on a handle member 110 causing an engaging tip within the locking mechanism 105 to extend through an opening in a first elongated support mechanism 115 and into contact with the second elongated support member 120. This contact prevents the second elongated support member 120 from upward movement within the slightly larger diameter first elongated support member 115.

The foot member 125, being supported by the locked second elongated support member 120 assumes the weight of the free-end of the gate 100, preventing strain on the opposing hinges and structural damage to the gate 100, which typically sags and bends in the absence of a supporting means. The gate support system further insures that the gate 100 remains in a fixed position during windy conditions or when the gate 100 is installed at an angle causing the gate 100 to naturally swing toward the downward slope.

To raise the foot member 125 to allow pivoting of the free-end of the gate 100, the user may press in on the handle 110 of the locking mechanism 105, thereby causing the binding shim to retract from the second elongated support member 120. The topmost end of the second elongated support member 120 has one end of a retraction spring attached, with the other end of the retraction spring attached to an end-cap on the topmost end of the first elongated support member 115. With the locking mechanism 105 releasing the second elongated support member 120, the retraction spring retracts the second elongated support member 120 toward the end cap of the first elongated support member 115, causing the foot member to raise from the surface. This leaves the free-end of the gate 100 able to pivot freely.

FIG. 2 illustrates a cutaway/transparent view of various components for an exemplary gate support system, in accordance with various embodiments. In various embodiments, the locking mechanism includes a handle 205, a handle pivot assembly 200, a cylindrical pin 210 for securing the handle 205 to the pivot assembly 200, and a binding shim 220, which is a portion of the handle 205. The handle 205 and binding shim 220 may be manufactured from a single portion of steel or similar hardened material. The handle portion 205 may be shaped to comfortably accommodate a human hand, while the opposing end (i.e., binding shim 220) narrows toward the end facing the second elongated support member 235. When the binding shim 220 is pressed against the exterior surface of the telescoped second elongated support member 235, the binding shim 220 binds the second elongated support member 235 to prevent up and down movement.

More specifically, the locking mechanism 200 is fixed to the outer surface of the first elongated support mechanism 230. In various embodiments, the locking mechanism 200 is secured to the first elongated support member 230 by way of welding. The locking mechanism 200 includes the pivoting handle member 205, which is maintained in an engaged position while at rest by way of a spring 215 that is positioned underneath the handle portion 205. The first elongated support member 230 includes an opening 225 that is large enough to accommodate the binding shim 220 portion of the handle member 205, to allow the binder shim 220 to engage and disengage from a second elongated support mechanism 235 that is positioned within the shaft of the first elongated support mechanism 230. When the handle member 205 is at rest and is forced outward from the locking mechanism 200 by way of the handle spring 215, the handle member 205 pivots and extends the binder shim 220 end of the handle member 205 in through the opening 225 of the first elongated support member 230. This creates a binding action on the second elongated support member 235, preventing it from moving further upwardly into the first elongated support member 230. As a result, the foot member at the lowermost end of the second elongated support member 235 engages the ground and thereby supports the weight of the free-end of the gate.

FIG. 3 is a perspective detail view of a locking mechanism for an exemplary gate support system, in accordance with various embodiments. As described herein, the first elongated support member 320 is configured such that a second elongated support member (not shown) is able to form a telescope-type integration. The second elongated support member includes a foot member (not shown) at the end opposite the telescoping configuration. A bias means (e.g. retraction spring) is secured within the first elongated support member, biasing the second elongated support member and the foot member upwardly to a normally raised position.

In various embodiments, the topmost end of the retraction spring is fixed to the topmost end of the second elongated support member by way of a pin or any other known securing method. In another embodiment, the topmost end of the retraction spring is fixed to an end cap, such that the end cap securely attaches to the topmost end of the first elongated support member.

In various embodiments, the lowermost end of the retraction spring is secured to the topmost end of the second elongated support member. Because the second elongated support member is telescopically received within first elongated support member, the retraction spring draws the second elongated support member upward, into the hollow tubular portion of the first elongated support member 320 until the foot member is positioned vertically as desired.

The locking mechanism 300 may be fixed to the first elongated support member 320 by way of a weld. However, those of ordinary skill in the art will appreciate that there are a number of methods for strongly adhering the locking mechanism 300 to the first elongated support member 320. In one embodiment, the locking mechanism 300 is integrated with the first elongated support member 320, such as when the gate support system is manufactured with the gate 330, rather than in a retrofitting scenario. In another embodiment for retrofitting the gate support system to an existing gate 330, each of the herein disclosed components are maintained as a single unit, which may be conveniently attached to a free-end of a gate 330 by way of clamps 325 or any other means known in the art.

In various embodiments, the locking mechanism 300 includes a handle member 310, which pivots on a pin 305 to control the position of the binder shim. To ensure that the binder shim remains in an engaged, and therefore locked position, a sprint or similar device is position underneath the handle member 310.

FIG. 4 is a macro view of the components for an exemplary gate support system, in accordance with various embodiments. The gate support system included a first elongated support member 425 and a second elongated support member 430 that are telescopically joined. The first elongated support member 425 includes a retraction spring 410 that is positioned within the central bore. The retraction spring 410 includes a first end, which is secured to an end cap 405 of the first elongated support member 425. A second end of the retraction spring 410 is secured to a first end of the second elongated support member 430.

In various embodiments, the second elongated support member 430 comprises a section of tubular steel having a diameter that is less than the diameter of the first elongated support member 425, such that the second elongated support member 430 is able to move unidirectionally within the central bore of the first elongated support member 425. However, those of ordinary skill in the art will appreciate that this is a design choice and the disclosed system may be configured such that the first elongated support member 425 telescopes into the inner bore of the second elongated support member 430, for example. Variously rearranging the disclosed components is contemplated by the inventor and the presently described order of components is presented for understanding only and does not limit the scope of the invention.

In various embodiments, the foot member 435 is engaged such that it bears the weight of the free-end of the gate. For example, when the free-end of the gate is pivoted to a desired open or closed position, the user can step down on the foot member 435, while slightly lifting the free-end of the gate until the foot member 435 is optimally positioned on the ground.

It is to be understood that the above description is intended to be illustrative, and not restrictive. For example, the above-discussed embodiments may be used in combination with each other. Many other embodiments will be apparent to those of skill in the art upon reviewing the above description.

Benefits, other advantages, and solutions to problems have been described herein with regard to specific embodiments. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.”

Where a phrase similar to “at least one of A, B, and C” or “at least one of A, B, or C” is used in the claims or specification, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Furthermore, no element, component, or method step in the present disclosure is intended to be dedicated to the public regardless of whether the element, component, or method step is explicitly recited in the claims. No claim element herein is to be construed under the provisions of 35 U.S.C. 112 (f) unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A system for supporting a free-end of a swinging gate comprising:
an first elongated support having a first circumference;
a removable end cap positioned on a first end of the first elongated support
a second elongated support having a second circumference, the second circumference being less than the first circumference, such that the second elongated support is slid into a second end of the first elongated support;
a retracting spring having a spring first end attached to the end-cap and a spring second end attached to the first end of the of the second elongated support;
a pivoting handle and assembly affixed to and outer surface of the first elongated support, wherein an engaging end of the pivoting handle passes through an opening in the first elongated support to engage the second elongated support; and
a foot member affixed to a second end of the second elongated support, wherein the foot member comprises a generally planner material for engaging a surface area.

2. The system of claim 1, wherein a cross section of at least one of: the first elongated support or the second elongated support is circular.

3. The system of claim 1, wherein a cross section of at least one of: the first elongated support or the second elongated support is rectangular.

4. The system of claim 1, wherein the foot member is a rectangular sheet of a metal.

5. The system of claim 1, wherein the pivoting handle includes a spring positioned underneath an end of the pivoting handle to maintain engagement with the second elongated tubular support.
